(19) United States
(12) Patent Application Publication
(10) Pub. No.: US 2005/0136378 A1
(43) Pub. Date: Jun. 23, 2005

(54) Implant system and method of installation thereof

(76) Inventors: Elmekki Ennajimi, Dollard-Des-Ormeaux (CA); Abdeslam Kasseh, Montreal (CA); Jamal Chaouki, Pointe-Claire (CA); Gustavo Labbe, Pointe-Claire (CA)

Correspondence Address: ELMEKKI ENNAJIMI, 62, rue AUDUBON, DOLLARD - DES - ORMEAUX, QC, H9B 3E9, CA

(21) Appl. No.: 10/740,050

(22) Filed: Dec. 19, 2003

(51) Int. Cl. A61C 8/00

(52) U.S. Cl. 433/173

(57) ABSTRACT

The present invention provides an implant system of facilitated use and installation which comprise an implant and a prosthesis support and a method of installation thereof. The prosthesis support disclosed herein includes an abutment and a collar member. Prior art implant systems are mostly made of metallic parts which are assembled with a screw and are shaped to receive a tooth prosthesis. The design of the abutment allows it to be made from highly filled composite materials being of a better optical quality and being easily machinable and further allows its installation without the use of a screwing member. The design of the collar member allows minimization of bacteria growth and tartar formation. The optimization of the implant system proposed herein may reduce stress to the jaw bone and therefore minimize the risk of injury for the patient.

### FIELD OF THE INVENTION

The present invention relates to an implant system, a kit and a method of installation thereof. More particularly, the present invention relates to an implant system of facilitated use, assembly and installation.

### BACKGROUND OF THE INVENTION

It is of general knowledge that the loss of teeth may be compensated by artificial dental implants. A dental implant system typically includes an implant which is inserted firmly into the bone and an abutment which is usually directly or indirectly attached to the implant with a screwing member. The abutment supports the gum tissue and serves as a foundation for the dental prosthesis. The core of the implant is shaped to receive the abutment and an accurate mechanical interconnection is therefore provided between the two components. Such dental implant systems are described, for example, in U.S. Pat. No. 5,810,589, issued Sep, 22, 1998, and U.S. Pat. No. 5,759,036, issued Jun. 2, 1998. More particularly, U.S. Pat. No. 5,810,589 discloses an abutment which comprises a threaded post providing attachment of the abutment with the implant.

In the prior art, the implant is first inserted into the bone and tissue ingrowth is allowed to take place. Once the implant is firmly anchored in the surrounding bone tissue and the bone has healed, the abutment is attached to the implant with an attaching means such as a screw. The abutment may be a metal structure which serves as a foundation to receive a prosthetic device such as a crown or a bridge. The prosthetic device is subsequently fabricated using traditional impression modeling techniques. Prosthetic devices usually possess a metal core to provide a metal to metal interconnection with the abutment.

Prior art implant systems are submitted to a significant stress load, mainly supported by the implant and which is transferred to the bone. In fact, conventional dental implant systems generally do not adequately distribute the loads and stresses. Since dynamic forces are not always on a vertical plane the bone is loaded with forces pulling in different directions. These forces often lead to a tendency of the implant to rotate, therefore acting upon softer bone matrix.

For example, U.S. Pat. No. 5,030,095, issued Jul. 9, 1991, discloses an abutment having two parts, the first being a platform joined to a post having screw threads and the second having a head joined to a shaft which is adapted for insertion into the first part and which needs to be screwed into an implant. This type of arrangement allows, for example, an angled head to be oriented in a more precise manner than with conventional system. However, the possibility of the components loosening and the stress imposed to the bone upon screwing the second part into the implant are two important factors unequivocally remaining with this type of system.

Several problems have also been identified with conventional implant systems and with their use and installation:
the metal-implant to metal-abutment fixation requires a screw and a chimney for accessing it. The use of screws increases the overall cost of the installation. In addition, screws have a tendency to become loose over time
the metal-to-metal interconnection between the abutment and the implant is very rigid and therefore submits the bone to a significant stress load;
the installation and assembly of conventional implant system (with a screw) in the patient's mouth requires great accuracy;
metallic abutments cannot be shaped or carved and therefore, an associated impression coping and supplementary device (e.g., analogue system) is required for allowing a dental technician to generate the crown or bridge in a laboratory. The overall installation of conventional systems requires several visits to the dentist and a high cost for the patient;
metallic dental implant components are supplied in standard dimensions making it difficult to adjust to desired shape and size; and
the use of metallic abutments result in a prosthetic tooth with undesirable aesthetic properties.

Recognizing the inconvenience of metal core abutments, other systems and methods have been developed. For example, U.S. Pat. No. 6,048,203, issued Apr. 11, 2000, uses fiber reinforced composite material coated with ceramic optimized polymer. U.S. Pat. No. 6,497,573, issued Dec. 24, 2002, discloses composite abutment having a metallic core, a shield surrounding the core and a polymeric cuff surrounding the core and shield.

Further improvement in dental implant systems and their installation are needed.

### SUMMARY OF THE INVENTION

The implant system of the present invention may include an implant and a tooth prosthesis. More particularly, the implant system of the present invention may include a three-component system which may comprise, for example, an implant, a collar member and an abutment.

As used herein, an “implant” is to be understood as a component of an implant system that is anchored into the bone. In parallel, an “abutment” is one of the components of the implant system that provides anchoring to the implant and allow fixation of the prosthesis.

The present invention provides an implant system of a design allowing its assembly without the use of a separate attaching means, e.g., a coupling fastener.

More particularly, the present invention provides, in one aspect thereof, an implant system which may comprise:
a) an implant which may have an elongated tubular body extending about a central longitudinal axis, the implant may also have a first opened end and a second closed end, an inner surface and an outer surface; and
b) a prosthesis support including a post,
   the prosthesis support may be so configured and sized as to be inserted into the implant by substantially linear translation insertion of the post into the open end of the implant. The post may have, for example, a substantially smooth surface.

The prosthesis support and the implant may be so configured as to be fixed to each other by an attaching means other than a screwing means.

As used herein the expression “a prosthesis support” is to be understood as a combination between an abutment and a collar member of the present invention.

In accordance with the present invention, the prosthesis support may comprise for example;
a) an abutment which may have an abutment head integral with the post, and;
b) a collar member (e.g., downwardly and inwardly curving) having a longitudinal passage therethrough.

Furthermore, the abutment may be so configured and sized as to be assembled with the collar member by a substantially linear translation insertion of said post into said passage of the collar member. The abutment and the implant may be so configured as to be fixed to each other by an attaching means other than a screwing means.

Also as used herein, the expression “a substantially linear translation insertion” is to be construed herein and in the appended claims as an insertion which does not require a screwing motion neither directly or indirectly, e.g., via a discrete fastener or screwing member. It is to be understood herein that the positioning of the abutment and the implant may require a slight rotational motion for aligning one component with the other(s). This type of motion is to be understood as distinct from a screwing motion.

Similarly, the expression “non-screwable prosthesis support” or “non-screwable abutment” is to be construed herein and in the appended claims as a prosthesis support or an abutment which is not configured to be screwed into an implant, i.e., the post does not have a threaded section configured to interact directly with a threaded portion of the implant, nor configured to be attached by a separate coupling member via a screwing action.

In a further aspect, the present invention provides an implant system which may comprise;
a) an implant which may have an elongated tubular body extending about a central longitudinal axis, the implant may also have a first end and a second end, an inner surface and an outer surface, the first end may be opened and may include a shouldered portion and the second end may be closed, and;
b) a cemented assembly or a non-screwable prosthesis support which may comprise
   an abutment which may include an abutment head, a projection for engagement within said shouldered portion, and a post; and
   a collar member (e.g., downwardly and inwardly curving) which may have a longitudinal passage therethrough;
      the abutment and the implant may be so configured as to be fixed to each other by an attaching means other than a screwing means, also the projection and the shouldered portion may be so configured as to allow assembly of the abutment with the implant in a substantially linear translation insertion manner (motion).

In accordance with the present invention, the abutment may be made, for example, from a highly filled composite material. The collar member may be made, for example, from a material that may be selected from the group consisting of a zirconium oxide and a zircon ceramic. The implant may be made, for example, from titanium.

According to a third aspect of the present invention, there is provided a method for installing the system described hereinabove into a bone tissue of individual in need, said method may comprise:
a) installing the implant into a bone tissue;
b) shaping the abutment to a desired configuration, and;
c) assembling the prosthesis support (abutment and collar member) onto the implant as described herein.

The method may also comprise fixing the abutment and the implant with composite cement.

Therefore, it is to be understood herein that a direct and indirect restoration technique and their respective installation method are encompassed by the present invention.

In a further aspect, the present invention provides a kit comprising;
a) an implant and;
b) a prosthesis support (i.e., an abutment and a collar-member).

In accordance with the present invention, the kit may further comprise a cover screw. The kit may also further comprise a healing screw. The kit may also comprise an impression copying.

It is to be understood herein, that if a “range” or the like is mentioned with respect to a particular characteristic (e.g. temperature, density, time and the like) of the present invention, it relates to and explicitly incorporates herein each and every specific member and combination of sub-ranges or sub-groups therein whatsoever. Thus, any specified range or group is to be understood as a shorthand way of referring to each and every member of a range or group individually as well as each and every possible sub-ranges or sub-groups encompassed therein; and similarly with respect to any sub-ranges or sub-groups therein, for example;
with respect to a flexural strength of between 200 and 1000 Pa, it is to be understood as specifically incorporating herein each and every individual range or values, as well as sub-range, such as for example 300±, 400±20, 700, 558.9, 994, 1000 etc.;
similarly with every other characteristics or range defined herein.

The content of each publication, patent and patent application mentioned in the present application is incorporated herein by reference.

### BRIEF DESCRIPTION OF THE DRAWINGS

In drawings which illustrate embodiments of the present invention:

FIG. 1a is a cross-sectional view of an abutment which is part of an implant system according to a first embodiment of the invention;

FIG. 1b is a side perspective view of the abutment of FIG. 1a;

FIG. 2a is a cross-sectional view of a collar member which is part of the implant system according to a first embodiment of the present invention.

FIG. 2b is a side perspective view of the collar member of FIG. 2a;

FIG. 3a is a cross-sectional view of an implant which is part of an implant and abutment system according to a first embodiment of the invention;

FIG. 3b is a side-perspective view of the implant of FIG. 3a;

FIG. 4a is a cross-sectional view of the implant system upon assembly of the abutment of FIG. 1a, the collar of FIG. 2a, and the implant of FIG. 3a according to a first embodiment of the invention;

FIG. 4b is a top view of the implant system of FIG. 4a;

FIG. 5a is a side elevation view of a cover screw to be used with the implant of FIG. 4a;

FIG. 5b is cross-sectional view of the cover screw of FIG. 5a assembled with the implant of FIG. 4a;

FIG. 6a is a side elevation view of a healing screw to be used with the implant of FIG. 4a;

FIG. 6b is a cross-sectional view of the healing screw of FIG. 6a assembled with the implant of FIG. 4a;

FIG. 7a is a bottom view of an abutment having a projection according to an embodiment of the invention;

FIG. 7b is a bottom view of an abutment having a projection according to another embodiment of the invention;

FIG. 7c is a bottom view of an abutment having a projection according to a further embodiment of the invention;

FIG. 7d is a bottom view of an abutment having a projection according to another embodiment of the invention;

FIG. 8a is a cross-sectional front view of an implant system according to a second embodiment of the invention (V; vestibular side, D; distal side);

FIG. 8b is a cross-sectional side view of the implant system of FIG. 8a (M; mouth side, L; lingual side);

FIG. 8c is a top view of the implant system of FIG. 8a;

FIG. 9 is a cross-sectional view of an implant system according to a third embodiment of the present invention;

FIG. 10a is a cross-sectional front view of an implant system according to a fourth embodiment of the invention (V; vestibular side, D; distal side);

FIG. 10b is a cross-sectional side view of the implant system of FIG. 10a (M; mouth side, L; lingual side);

FIG. 10c is a top view of the implant system of FIG. 10a;

FIG. 11a is a cross-sectional view of an implant system according to a fifth embodiment of the invention;

FIG. 11b is a cross-sectional view of an implant system according to a sixth embodiment of the invention;

FIG. 11c is a cross-sectional view of an implant system according to a seventh embodiment of the invention;

FIG. 12a is a cross-sectional view of an impression copying used according to an embodiment of the invention; and

FIG. 12b is an elevation view of a screw for the impression copying of FIG. 12a.

### DETAILED DESCRIPTION

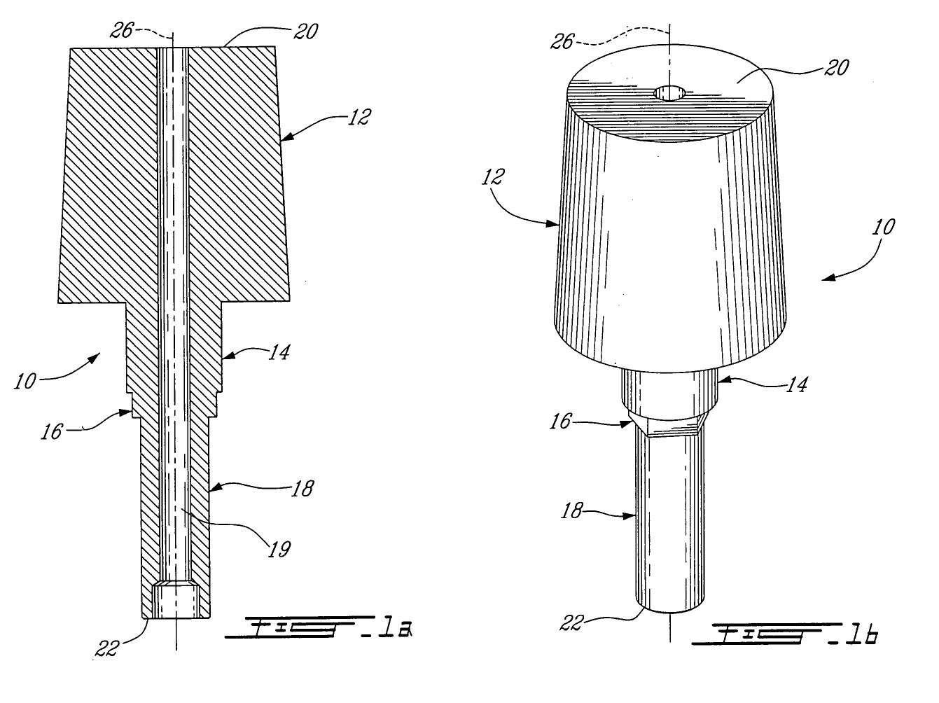

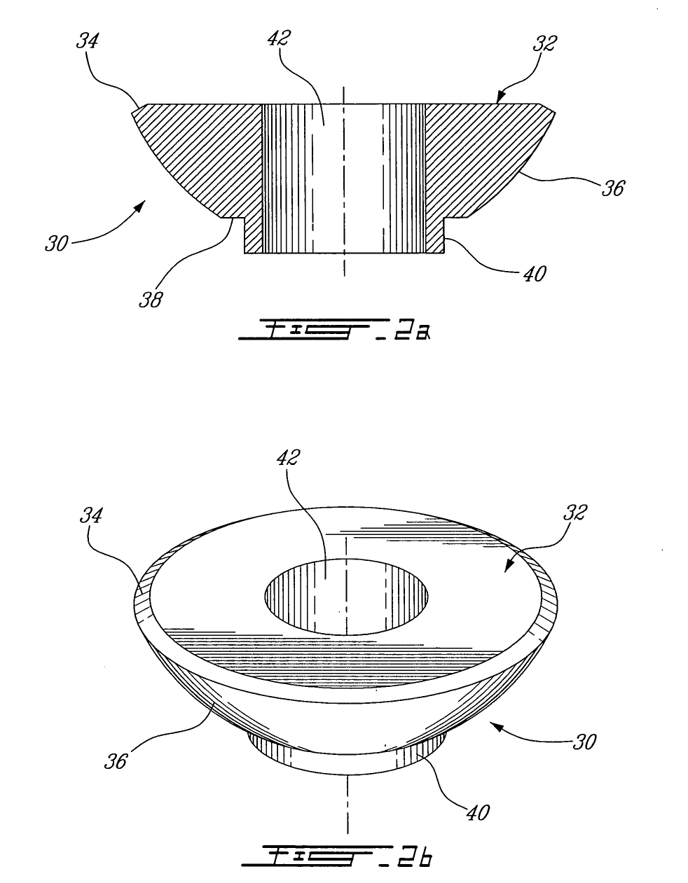

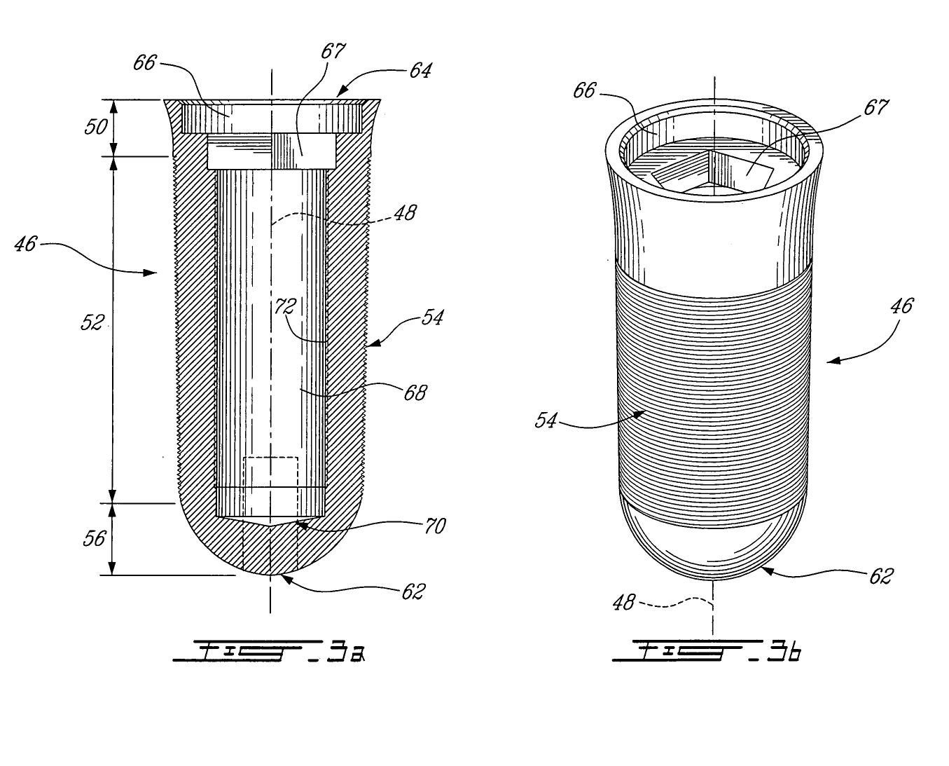

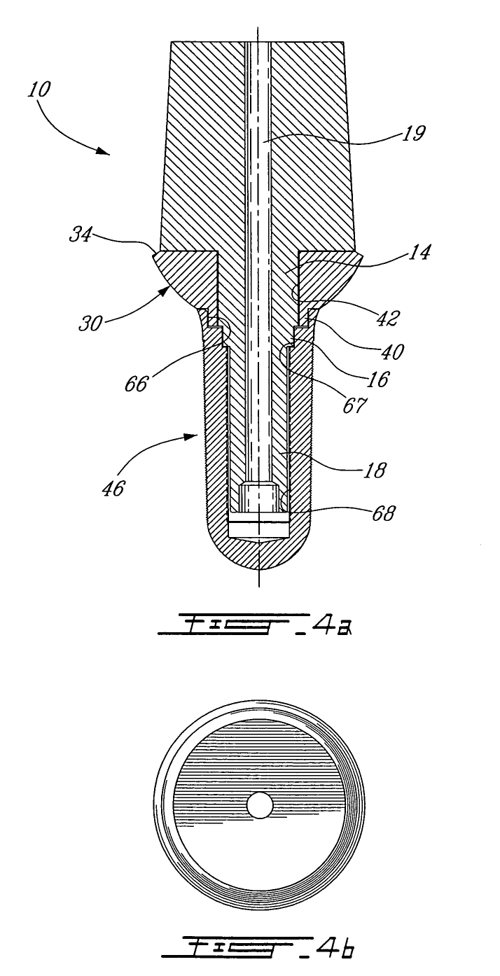

Referring now to FIGS. 1a to 4b, an implant system according to a first embodiment of the present invention will be described. The implant system includes a prosthesis support in the form of the combination of an abutment 10 illustrated in FIGS. 1a and 1b and a collar member 30 illustrated in FIGS. 2a and 2b; and an implant 46 illustrated in FIGS. 3a and 3b. FIGS. 4a and 4b illustrate the assembly of the prosthesis support and the implant 46.

Turning now more specifically to FIGS. 1a and 1b, the abutment 10 includes an external member defined by an abutment head 12 of a frusto-conical shape, adjacent to a junction segment 14 which is connected to a projection 16 of a substantially polygonal shape. The projection 16 of the abutment 10 is adjacent to an elongated post 18. The abutment head 12, the segment 14, the projection 16 and the post 18 may be integrally made of a single piece of material.

The abutment 10 includes a central throughbore 19 which spans the entire length of the abutment 10 starting from a surface 20 of the abutment head 12 and ending at a surface 22 of the post 18.

The abutment head 12 starts from surface 20 and downwardly and outwardly extends until the junction segment 14 is reached. The junction segment 14 is illustrated as having a substantially cylindrical shape ending with a flat surface connected to the projection 16. The projection 16 is also connected to the post 18. The abutment head 12, junction segment 14, projection 16 and post 18 are coaxial and parallel to the abutment central axis 26.

FIG. 1b, better illustrates projection 16 which is shown as being generally pentagonal.

FIGS. 2a and 2b illustrate the collar member 30 which has a generally toroidal shape when seen from a top view. The collar member 30 starts with a substantially planar top surface 32 having a downwardly and outwardly extending flange 34 and continues with a downwardly and inwardly curved section 36. The curved section 36 ends with a shoulder 38 which is connected to a cylindrical section 40. The collar member 30 is illustrated has having a passage 42 therethrough. As will be clear from the following description, the collar member may take other shapes such that one side may be higher than the opposite side (a contoured collar member).

FIGS. 3a and 3b illustrate the implant 46 which is configured and sized to be used with the abutment 10 of FIGS. 1a and 1b and the collar member 30 of FIGS. 2a and 2b as will be further described.

The implant 46 has a generally elongated tubular body extending about a central longitudinal axis 48 and is defined by a head section 50, a root section 52 and a generally tapered section 56. The sections 50, 52 and 56 are being integrally made of a single piece of material.

The head section 50 becomes the elongated root section 52 which is generally tubular as will be described hereinbelow. The elongated root section 52 is shown has having threads 54 on its outer surface (shown in FIG. 3b). The purpose of the threads 54 will be described hereinbelow.

The elongated root section 52 ends with an inwardly and downwardly tapered section 56 having a rounded tip 62 defining a closed end of the implant 46.

The open end 64 of implant 46 has two shoulder portions 66 and 67, having a substantially cylindrical shape and a substantially pentagonal shape, respectively, as can be better seen in FIG. 3b. These shoulder portions further extend into a central bore 68. The central bore 68 downwardly extends and ends with a tapered section 70. The inner surface of the implant 70 includes a threaded portion 72, the purpose of which will be described hereinbelow.

As can be better seen from FIG. 3b, the shoulder portion 66 is so configured and sized as to receive the cylindrical section 40 of the collar member 30. Similarly the shoulder portion 67 is so configured and sized as to receive the projection 16 of the abutment.

FIGS. 4a and 4b, illustrate the assembled implant system according to a first embodiment of the present invention. The abutment 10 is shown sitting onto the collar member 30 and inserted into the implant 46. FIG. 4b is a top view of the implant system of FIG. 4a, showing the substantially circular shape of each of the component of the implant system, when seen from a top view.

As may be glanced from FIG. 4a, the junction segment 14 of the abutment is so configured and shaped to fit the passage 42 of the collar member 30. In addition, the projection 16 and post 18 of the abutment 10 are configured and sized to fit the shoulder portion 67 and the central bore 68 of the implant 46, respectively. Furthermore, the cylindrical portion 40 of the collar member is also configured and sized to fit with the shoulder portion 66 of the implant. This type of configuration of each of the component insures stability and easy installation of the implant system of the invention. Furthermore, as may be seen from FIG. 4a, flange 34 of the collar member 30 extends beyond the base of the abutment head 12. Flange 34 thus serves as a base for supporting a dental prosthesis.

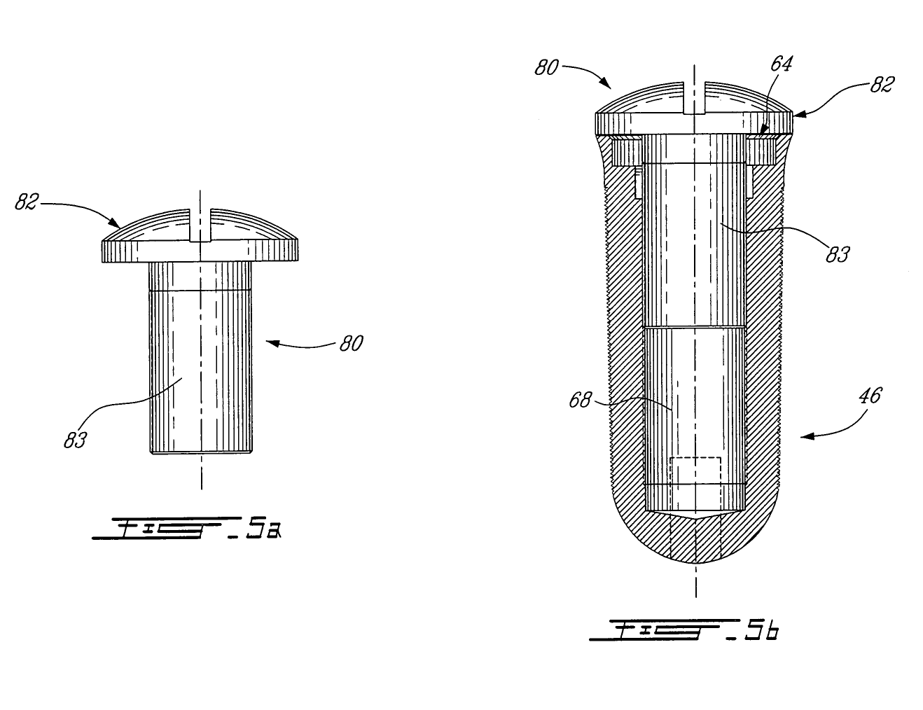

FIG. 5a illustrates a cover screw 80 used during one of the installation step of the implant system. The cover screw 80 is shown has having a substantially flat head 82 which is connected to a threaded post 83. FIG. 5b illustrates the cover screw secured to the implant 46 of FIGS. 3a and 3b. As may be seen from FIG. 5b the head 82 of the cover screw 80 sits on top of the open end 64 of the implant and therefore provides a seal of the central bore 68.

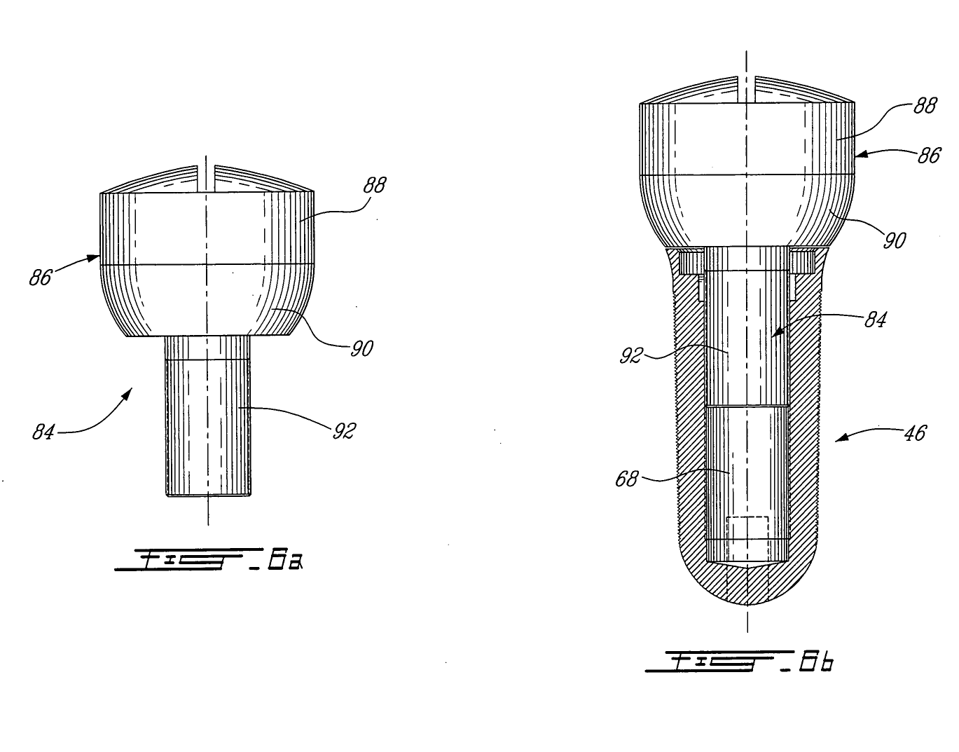

FIG. 6a illustrates a healing screw 84 which is also used during one of the installation step of the implant system of the invention. The head 86 of the healing screw 84 has a cylindrical section 88 and a curved section 90 and is connected to a threaded post 92. The curved section 90 of the healing screw mimics the curved section 36 of the collar member 30 of FIGS. 2a and 2b. FIG. 6b illustrates the healing screw secured over the implant 46. The healing screw 84 also provides a seal of the central bore 68.

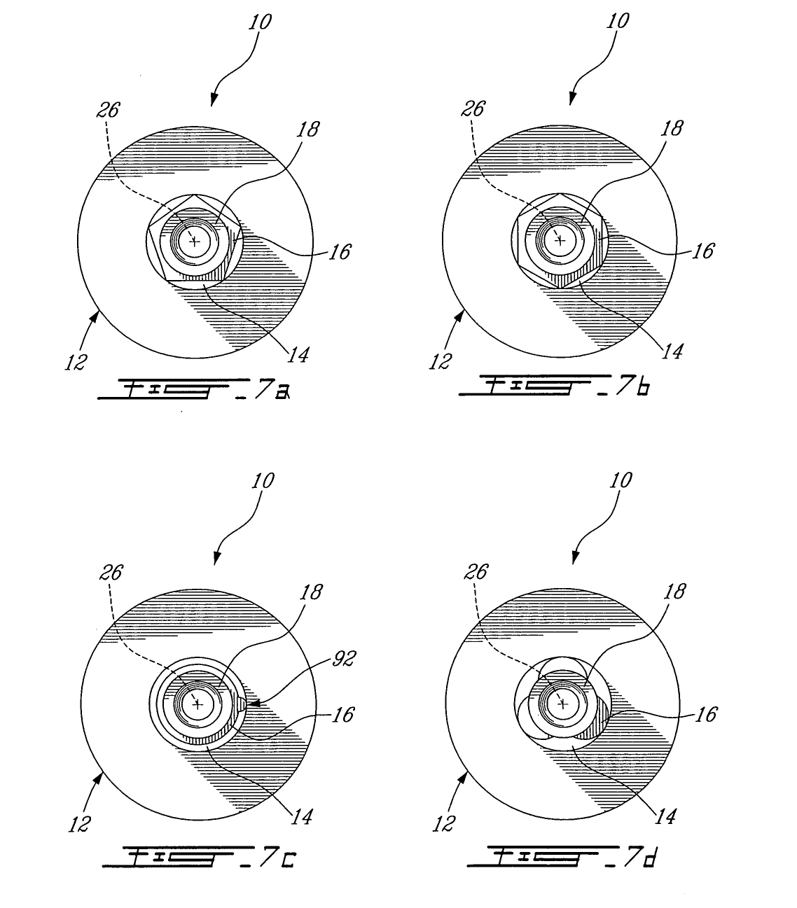

FIGS. 7a to 7d, illustrate bottom views of abutments 10 having a projection 16 of varying shape according to other embodiments of the present invention. FIG. 7a is a bottom view of the abutment of FIG. 1a. FIG. 7a better illustrates the pentagonal shape of projection 16. For purpose of concision, FIG. 7b to 7d will be described only with respect to their differences relative to FIG. 7a. As may be seen, FIG. 7b illustrates an abutment 10 having a projection 16 of a hexagonal shape. FIG. 7c illustrates an abutment 10 having a projection 16 of a substantially cylindrical shape and further having an aligning means 92 in the form of a ridge. FIG. 7d illustrates an abutment 10 having a projection of an irregular shape.

The installation of the implant system of FIGS. 4a and 4b may proceed as follows. First, the oral surgeon access the patient's jawbone through the patient's gum tissue and remove any remains of the tooth to be replaced. Next, the anchoring site where the implant 46 is to be installed may be widened to accommodate the implant 46. The implant 46 is inserted into the jawbone, typically by screwing it with the help of the its external threads 54, although other methods may be used.

It is to be noted that it may be useful to install the implant so that one side of the projection 16 (e.g., when polygonal) is parallel with either face (external or internal) of the gum. This may facilitate the surgeon's work as it may provide a point of reference for subsequent alignment of the abutment 10.

The cover screw 80 is secured on top of the implant 46 by screwing the threaded post 83 into the implant 46 using the internally threaded portion 72 of the central bore 68. The patient's gum is then sutured over the sealed implant 46. Tissue ingrowth (i.e., ossointegration) is allowed to take place for about 3 to 8 months. The external threads 54 help in stabilizing and anchoring the implant 46 into the bone and/or minimize rotation of the implant 46 with respect to the bone once tissue ingrowth is achieved.

Once the implant 46 is firmly anchored in the surrounding bone tissue and the bone has healed, the surgeon re-accesses the implant 46 by making an incision through the patient's gum tissue. The cover screw 80 is removed and a healing screw 84 is installed by screwing its threaded post 92 in to the implant 46. Within the next few days or weeks the gum tissue will heal and will surround the healing screw 84 mainly at the level of its curved section 90. The cylindrical section 88 of the healing screw 84 extends further from the gum line.

The configuration of the healing screw 84 allows the gum to take an appropriate shape for later installation of the collar member 30 and abutment 10. More particularly, since both the curved section 90 of the healing screw 84 and the curved section 36 of the collar member 30 have a similar configuration the gum will heal leaving an area which will adequately receive the collar member 30.

Once the gum has healed, the healing screw 84 is removed and the collar member 30 is installed onto the implant 46 or alternatively assembled with the abutment 10. The abutment 10 is then aligned with the implant 46 and inserted in a substantially linear translation movement.

As will be clear from the description and drawings, the assembly of the implant system may be carried in more than one way. For example, the abutment may first be inserted into the collar member's passage and second being joined, by a substantially linear translation insertion, with the implant. Alternatively, the collar member may be positioned onto the implant and the abutment may then be inserted through the collar member's passage and into the implant central bore by a substantially linear translation insertion. The assembly of the abutment 10 and collar member 30 is of the tight fit type.

Once the abutment 10 is shaped to the required configuration, using the direct or indirect technique which will be described hereinbelow, it may be permanently fixed to the implant 46 by the mordancy technique. For example, the post 18 of the abutment 10 may be acid etched. A composite cement may be inserted into the implant's central bore 68 (e.g., before assembling the prosthesis support with the implant) and both pieces are subsequently joined. The composite cement may thereafter be cured to insure a permanent fixation. As discussed herein, the threaded surface 72 serves to attach the cover screw, the healing screw (healing cup) and the impression copying. However, the threaded surface 72 also permits here a mechanical retention of the abutment 10 with the implant 46 during cementation. The central throughbore 19 of the abutment 10 allows the air under pressure and surplus sealing mordancy to escape the bore 68 upon assembly. The collar member 30 may be held between the abutment 10 and implant 46 without additional attachment. Therefore, the assembly and fixation mechanism of the implant system does not require the use of a screwing member, e.g., a separate screw or integral threaded post. A permanent fixation between the two components is thus provided and the use of a discrete fastener, such as a screw is avoided.

The dimensions of the junction segment 14, projection 16 and post 18 may be slightly smaller than the dimensions of the shoulder portions 66, 67 and central bore 68. Assembly of post 18 and central bore 68 is of the clearance fit type. Assembly of the projection 16 and shoulder portion 67 is of the slide fit type. A shock absorbing gap may thus be provided by the empty spaces between the abutment 10, collar member 30 and implant 46 surfaces. This arrangement may allow the abutment 10 to flex slightly relative to the implant 46 as it is submitted to chewing forces.

The materials which are suitable for the implant system of the present invention, include those described hereinbelow.

The abutment may be made from a material compatible with the CAD/CAM milling procedures and system and also compatible with hand operated dentistry tools such as chisels, milling machines, trimmers, etc. CAD/CAM systems are composed of a data acquisition and analysis unit as well as a machine that is able to shape machinable pieces based on a 3D model. Dental material that may be used with the CAD/CAM system are known in the art. These include for example, ceramics and highly filled composite material such as the following:
3M* Paradigm* MZ100 block for CEREC*; 85 Wt % ultrafine zirconia-silica ceramic particles that reinforce a highly crosslinked polymeric matrix. The polymer matrix consists of Bisphenol A diglycidyl ether dimethacrylate and triethylene glycol dimethacrylate.
Vita Mark II Vitabloc for CEREC*; This product is manufactured from fine particles of dental ceramics with wear characteristics similar to natural tooth enamel. This product has a homogenous microstructure and a flexural strenght of about 160 Mpa.
Lithium Disilicate for CAD/CAM (Jeneric Pentron, USA); This material is similar to OPC 3G (Jeneric Pentron, USA) and comprises about 60% of interlocked needle-shaped lithium disilicate crystals embedded into alumino-borosilicate glass matrix and possesses a resistance to cleavage of about 300 Mpa.
IPS Empress* 2; leucite-reinforced ceramic pressable containing latent nucleating agents. The leucite-reinforced ceramic powder is pressed into ingots and sintered.
   *Trademark

Other material which may be used to make the abutment of the implant system include: Vita Zeta HC Composite or Vita Zeta Heat Cure Composite, VitaPress, Ivoclar ProCAD blocks (this material is also reinforced with leucite particles).

A variety of highly filled composite material may be suitable for the abutment of the present invention. Such highly filled composite materials may have, for example, the following characteristics:
a composition comprising between 50 and 98% (w/w) of solid substrate, e.g., between 50 and 95% of solid substrate or for example, between 50 and 90% of solid substrate;
a density of between 2.0 and 3.8 g/cm³;
a flexural strength of between 100 and 600 MPa, for example between 100 and 450 MPa. Generally, the material used for the abutment 10 may be chosen based with a flexural strength which is similar to or slightly lower than the flexural strength of the implant 46;
a Young's modulus of between 4 and 200 GPa;
a flexural modulus of between 4 and 40 GPa;
a fracture toughness of between 0.6 and 1.5 GPa; and/or
a compressive strength of between 300 and 900 MPa.

When a highly filled composite material is used for the abutment 10, the aesthetic appearance (desired color, translucence) of the tooth prosthesis is improved. For example, the shade or color may be selected according to the color of the surrounding tooth or teeth which is not possible for metallic abutments. In addition, an abutment made from a highly filled composite material may be fixed to the implant by the mordancy technique which may prove difficult when using metallic components. Furthermore, fixation of the tooth prosthesis (e.g. porcelain) is more easily achieved.

According to embodiments of the present invention, the implant 46 may be made from a material allowing ossointegration, more particularly, a material such as titanium, titanium alloy, gold, zirconium oxide, aluminum oxide, ceramics, i.e., bio-ceramics (e.g., zircon ceramics), or other biocompatible material

Also according to embodiments of the present invention the collar member 30 may be made, for example, from a material such as titanium, titanium alloy, gold, zirconiumi oxide, or ceramics (e.g., zircon ceramics). Since the collar member is in close contact with the gum tissue, the use of zirconium oxide or zircon ceramics has been found to minimize the risk of bacteria growth, decrease tartar formation and increase the esthetic and optical quality of the dental fixture (shade, translucency). Ceramics used to make the collar member may include, for example, a ceramic made from aluminum oxide, zirconium oxide and the like as well as combination thereof. Such ceramics may have, for example, the following characteristics;
a density of between 2.4 and 6.2 g/cm³ (e.g., 2.4, 3.8, 3.9, 4, 5.8, 6.1, etc.);
an elastic modulus of between 100 and 380 GPa (e.g., 104±4, 350±20, 370±20, 360±20, 200±20, etc.);
a Poisson's ratio of between 0.22 and 0.34 (e.g., 0.22, 0.23, 0.30, 0.34, etc.);
a flexural strength of between 200 and 1600 MPa (e.g., 300±30, 400±20, 700±20, 900±30 1200±20, etc.);
a fracture toughness of between 2 and 15 MPa×m ½ (e.g., 2, 3, 4, 5, 6, 9, 13, 15, etc.)
a hardness of between 6 and 15 GPa (e.g., 6, 7, 12.8, 13.2, 13.6, 14.2, 14.6, 15, etc.) and/or
CTE (coefficient of thermal expansion) of between 9 and 11 10⁻⁶×° C.⁻¹ (e.g., 10.3 (from 25° C. to 1000° C.), 8 (from 25° C. to 1000° C.), etc.).

Two restorative options are possible using the implant system of the present invention, especially when a highly filled composite material is used to make the abutment (i.e., a material having the machinability advantages (properties) of a direct restorative material and those of an indirect restorative material):

A direct restorative technique : a dentist may shape the abutment to fit the required configuration directly in the patient's mouth for subsequent installation of the prosthetic tooth. It is possible to add or remove material from the abutment. This technique does not require impression coping or an impression copying. For example, material may be added or removed from the abutment head 12 depending on the shape, dimension and angularity (with respect to the implant or post) needed by the patient and determined by the dentist. The dentist therefore machines the abutment head 12 (e.g., using traditional dentistry tools) of the abutment 10 to fit with the prosthesis. The prosthesis is subsequently installed.

An indirect restorative technique: a dentist may take an impression of the patient's mouth using the impression copying (analogue system) described herein and the abutment may be sent to an outside laboratory which will shape the abutment to the required configuration (e.g., using a CAD/CAM system) based on the impression. The installation of the shaped abutment is thus performed as a separate step. The prosthesis is subsequently installed. The indirect approach requires more chair time.

Abutments 10, according to embodiments of the present invention may be provided with different shapes and dimensions such as, for example oval (e.g., when seen from a top view), circular, rectangular, frusto-conical, square or even irregular shapes may be used. The same applies for collar members 30 and implants 46. For example, the abutment 10, the collar member 30 and the implant 46 may be provided in a variety of sizes suitable for either lateral, central, cuspid and bicuspid teeth and for molars or suitable for the specific needs of an individual. The dimensions of the curved section 36 of the collar member 30 may vary to accommodate various tissue heights. Also, the junction segment 14 of the abutment may be tapering inwardly and downwardly toward the post. Therefore, any variation in shape, length, diameter, width, angularity etc. of any component or any individual part of a component of the implant system, impression copying, screws (cover, screw, healing screw, screw of the impression copying) of the present invention are encompassed herein.

As another example, the projection 16 may take any other shapes than the pentagonal shape illustrated in FIG. 1b. The projection may have any other suitable polygonal shape (e.g., hexagonal, etc.), oval shape or even an irregular shape. Implant system having projection 16 which tapers inwardly and downwardly are also encompassed by the present invention. Whatever the shape and size of the projection 16 it would be preferable to provide an implant 46 with a matching shoulder 67. It may be preferable to have a projection 16 with a low number of sides (e.g., a three-sided polygon, a five-sided polygon, a seven-sided polygon) for allowing alignment of the abutment 10 with the implant 46 in a limited number of positions. It may also be useful to have a projection 16 with an uneven number of sides.

As will easily be understood by one skilled in the art, the projection 16 only allows alignment of the abutment 10 with the implant 46 in a limited number of positions, five in the case of FIG. 1a and FIG. 1b. Alignment is performed by positioning the abutment 10 onto the implant 46 in such a way that the shape of the projection 16 of the abutment 10 is matched and fitted into the shouldered portion 67 of the implant 46. The projection 16 also prevents rotation of the abutment 10 with respect to the implant 46.

The expression “limited number of positions” is to be understood herein as the number of possible positions for inserting the abutment into the implant, this number being, for example preferably below 20 possible positions, more preferably below 10 possible positions.

It is also understood herein, that an abutment having a substantially circular shaped projection 16, may also serve for aligning the abutment with the implant, provided that the projection 16 would have one or more additional aligning means as illustrated by ridge 92 in FIG. 7c. Such additional aligning means may be, for example, selected from the group consisting of a protrusion, a notch, a ridge, a concave structure, a convex structure, a tapered structure, a pin, and combinations thereof. Therefore, the aligning means would also partially block or minimize rotation. Of course, in the event a projection 16 would have aligning means 92 (as illustrated in FIG. 7c), the shoulder portion 67 would also be configured to match it, e.g., in a male-female type of structure (not illustrated).

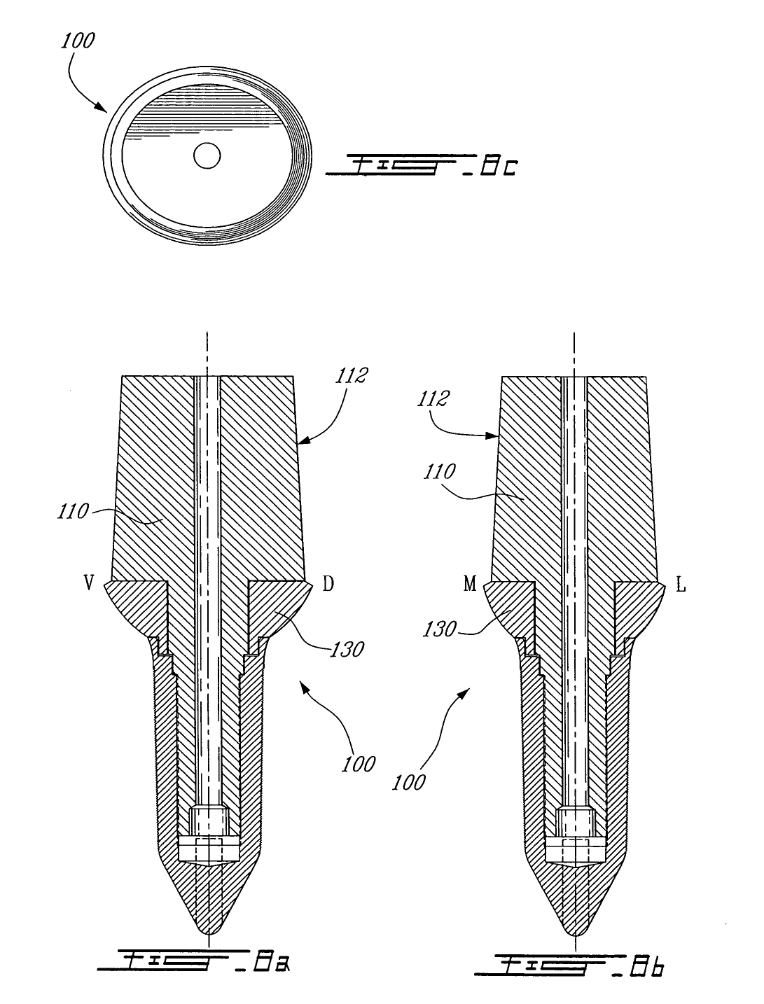

Turning now to FIGS. 8a, 8b and 8c, an implant system 100 according to another embodiment of the present invention will be described. It is to be noted that the implant system 100 of these figures is very similar to the implant system illustrated in FIGS. 1a to 6b. Therefore, for concision purposes, only the differences between these implant systems will be described hereinbelow.

The main difference between the implant system 100 and the implant system described hereinabove is that the abutment head 112 of the abutment 110 is substantially oval (when seen from a top view). In addition, the collar member 130 is also illustrated as having an oval shape. Those dimensions may be useful, for example, for an implant installed in place of a cuspid or bicuspid tooth. A position that the implant system may held once installed in the mouth of an individual is suggested in FIG. 8a and FIG. 8b where V is the vestibular side, D is the distal side, M is the mouth side and L is the lingual side. Other positions may be assumed depending on the need of the patient.

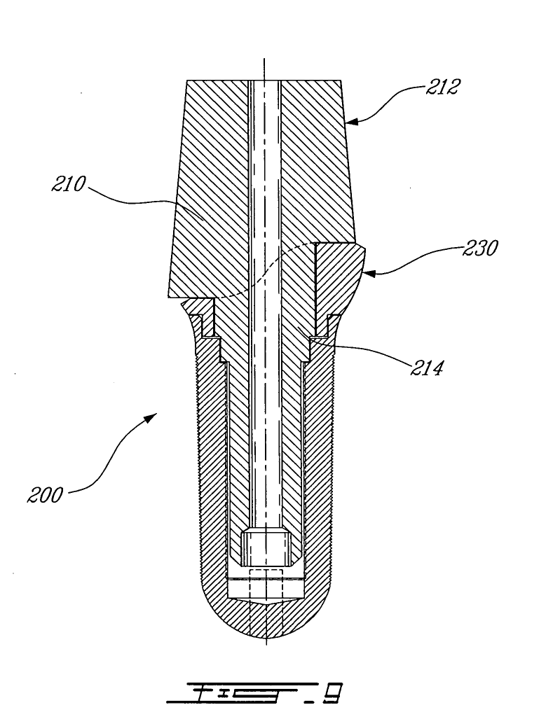

FIG. 9 of the appended drawings illustrates an implant system 200, according to a third embodiment of the present invention. Again, only the differences between the implant system 200 and the implant system described hereinabove with reference to FIGS. 1a to 6b will be described.

In FIG. 9, the collar member 230 is illustrated has having one of its side higher than the opposite side. This type of implant system or collar member 230 is referred as being contoured. Accordingly the abutment 210, more particularly the abutment head 212 and the junction segment 214, is adapted to fit with the contoured collar member. This type of system may be particularly useful for substantially circular or substantially square teeth, such as a molar, especially when one side of the gum tissue is higher than the opposite side (e.g., lingual v mouth).

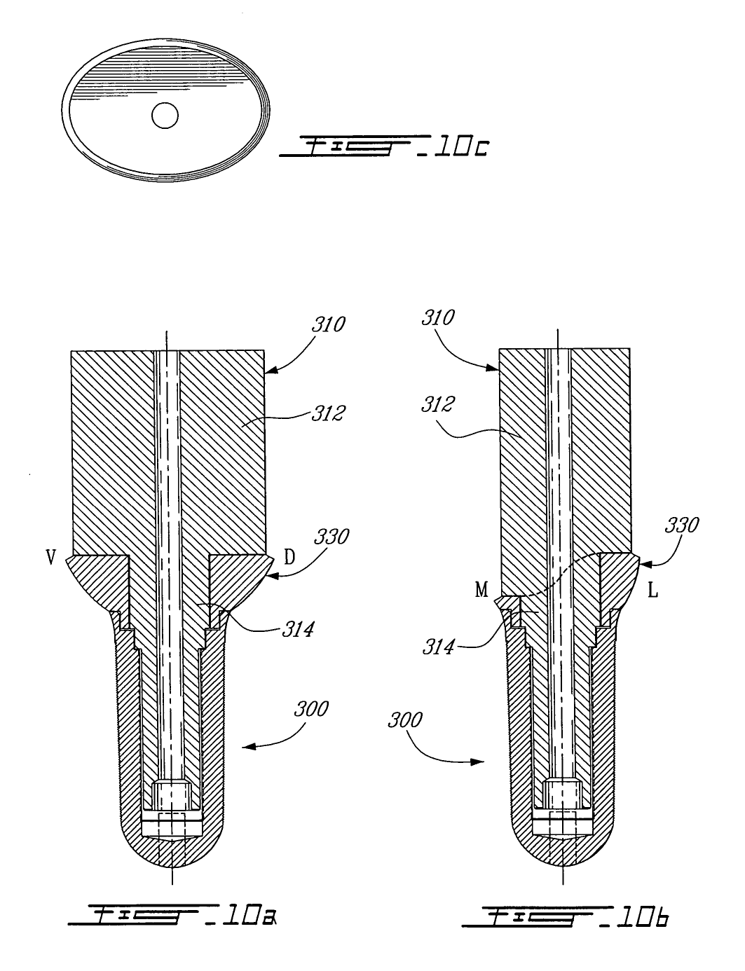

An implant system 300, according to a fourth embodiment of the present invention will now be described with reference to FIGS. 10a, 10b and 10c.

As shown in FIG. 10b, the collar member 330 is contoured as the collar member 230 of FIG. 9. In addition, the collar member 330 and the abutment 310 illustrated in FIGS. 10a, 10b and 10c have a substantially oval shape. Again, the abutment 310, more particularly the abutment head 312 and the junction segment 314, is configured to match the collar member 330. This type of system may be particularly useful for oval teeth, such as a cuspid or bicuspid tooth, especially when one side of the gum tissue is higher than the opposite side (e.g., lingual v mouth). A position that the implant system may held once installed in the mouth of an individual is suggested in FIG. 10a and FIG. 10b where V is the vestibular side, D is the distal side, M is the mouth side and L is the lingual side. Other positions may be assumed depending on the need of the patient.

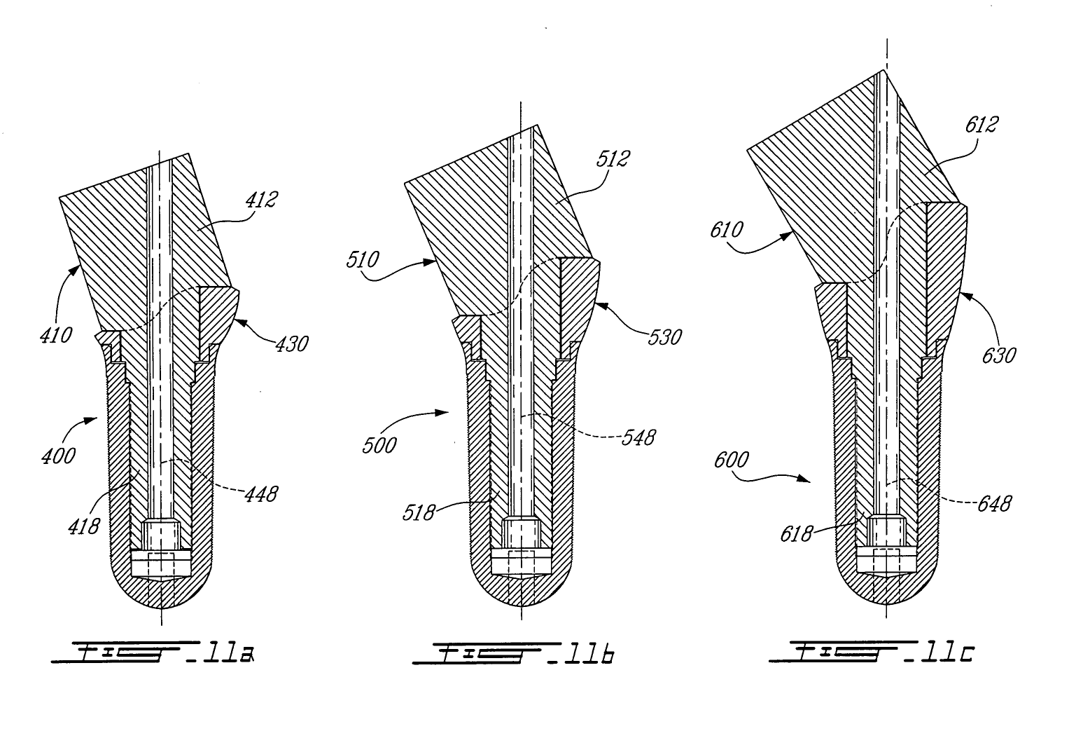

FIGS. 11a, 11b and 11c illustrate implant systems 400, 500, and 600 respectively according to additional embodiments of the present invention. In FIGS. 11a, 11b and 11c, the collar members 430, 530 and 630 are of the contoured type. However, the top surface of each abutment is at an angle with respect to the implant central longitudinal axis. The abutment 410 and more particularly the abutment head 412 of FIG. 11a is shown with an angle of approximately 18° with respect to the central longitudinal axis 448 (as well as with respect to the post 418). The abutment 510 and more particularly the abutment head 512 of FIG. 11b is shown with an angle of approximately 23° with respect to the central longitudinal axis 548 (as well as with respect to the post 518). The abutment 610 and more particularly the abutment head 612 of FIG. 11c is shown with an angle of approximately 30° with respect to the central longitudinal axis 648 (as well as with respect to the post 618). More particularly angles of between 15° and 35° (or −15° to −35°) are encompassed by the present invention. These types of implant system may be required depending on the specific needs of an individual which is easily determined by the dentist. Of course, the length, shape (oval v circular) size may vary as described herein.

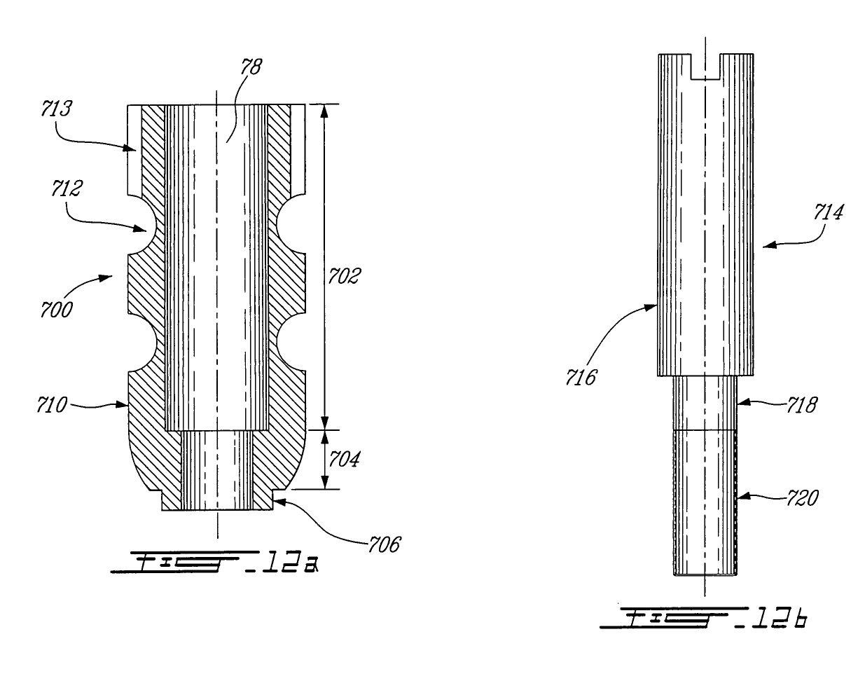

Turning now to FIGS. 12a and 12b of the appended drawings, an impression copying 700, compatible with the implant 46 will be described.

The impression copying 700 comprises an elongated section 702, a curved section 704 and a cylindrical section 706. The impression copying 700 has a channel 708 passing therethrough. The impression copying 700 possesses, on its external face 710, substantially horizontal grooves 712 and substantially vertical grooves 713 which are found on the elongated section 708. The curved section 704 of the impression copying mimics the curved section 36 of the collar member 30 illustrated in FIGS. 2a and 2b. The cylindrical section 706 of the impression copying 700 mimics the cylindrical section 40 of the collar member 30 as also illustrated in FIGS. 2a and 2b. The impression copying 700 may therefore be installed onto the implant 46 and may be temporarily held in place with the help of an attaching means such as a screw 714 as the one illustrated in FIG. 12b. The screw 714 of FIG. 12b has a substantially elongated cylindrical head 716, a junction segment 718 and a threaded post 720. Each part of the screw 714 matches the corresponding internal dimensions of the impression copying 700.

In use, the impression copying 700 is installed onto the implant 46 and secured with the help of a screw 714. An impression is then taken around the impression copying 700, using for example, a silicone material, such as an addition-curing silicone impression material, a condensation curing silicone impression material, etc. The impression copying 700 may afterward be removed. The laboratory uses the resulting impression to form a prosthetic tooth. The silicone impression will carry impressed threads matching grooves 712 and 713 which will therefore reflect the initial position of the impression copying 700 in the patient's mouth.

It is to be understood herein that an implant system having one or more of the individual characteristics described herein is encompassed by the present invention. For example, an implant system having an oval shaped implant, a contoured and oval shaped collar member and an oval shaped angled abutment is also encompassed by the present invention. Similarly, any of the individual characteristics in any implant system's components or any component's part may be mixed to provide a desired implant system in accordance with the present invention.

It may be advantageous in some instance to manufacture a collar member and abutment in a single piece. However, one main advantage of providing two distinct pieces is that both pieces may be made from distinct material as described herein.

The different components of the implant system (abutment, collar member, implant, which may include a cover screw and a healing screw) and impression copying (when required) may be provided in separate pieces to the dentist or as a standard set of defined dimensions. It may also be useful to have an abutment with the characteristics described herein specifically designed to be used with prior art implant. In addition, a separate implant having the characteristics described herein is also encompassed by the present invention.

Other variations of the invention encompassed by the present invention include the following. For example, the elongated post 18 of the abutment may be provided with a tapered section at its tip. A tapered section may generally increase the flow of mordancy upon fixation of the abutment 10 to the implant 46. Also, the tip 62 of the implant 46, illustrated in the appended figures as being rounded may be more pointed as illustrated in FIGS. 8a and 8b or may have other configuration.

In addition, it may be useful to provide a collar member having a threaded passage. This may facilitate assembly of the abutment and collar member when, for example, their assembly is required or preferable prior to their installation onto the implant. A prior assembly of an abutment and a collar member may be useful, for example, to prevent lost of one of the component or may facilitate their distribution to the customer.

Although the present invention has been described in details herein and illustrated in the accompanying drawings, it is to be understood that the invention is not limited to the embodiments described herein and that various changes and modifications may be effected without departing from the scope or spirit of the present invention.

1. An implant system comprising:
a) an implant having an elongated tubular body extending about a central longitudinal axis, said implant having a first opened end and a second closed end, an inner surface and an outer surface; and
b) a prosthesis support including a post,
wherein said prosthesis support is so configured and sized as to be inserted into said implant by substantially linear translation insertion of said post into said open end of said implant.

2. The implant system of claim 1, wherein said prosthesis support and said implant are so configured as to be fixed to each other by an attaching means other than a screwing means.

3. The implant system of claim 2 wherein said attaching means is a composite cement.

4. The implant system of-claim 2, wherein said prosthesis support comprises:
a) an abutment having an abutment head integral with said post, and;
b) a collar member having a longitudinal passage therethrough.

5. The implant system of claim 4, wherein said abutment is made from a material other than a metallic material.

6. The implant system of claim 5, wherein said material material having the machinability advantage of a direct restorative material and those of an indirect restorative material.

7. The system of claim 4, wherein said abutment is made from a material selected from the group consisting of ceramics and highly filled composite materials.

8. The system of claim 5, wherein said composite material is machinable using a CAD/CAM system.

9. The system of claim 5, wherein said composite material is machinable using hand operated dentistry tools.

10. The system of claim 7, wherein said highly filled composite material has a composition comprising between 50 and 98% (w/w) of solid substrate.

11. The system of claim 7, wherein said composite material, has a flexural strength of between 100 and 600 MPa.

12. The system of claim 11, wherein said composite material has a flexural strength of between 100 and 450 MPa.

13. The system of claim 7, wherein said composite material has a density of between 2.0 and 3.8 g/cm³.

14. The system of claim 7, wherein said composite material has a Young's modulus of between 4 and 200 GPa.

15. The system of claim 7, wherein said composite material has a flexural modulus of between 4 and 40 GPa.

16. The system of claim 7, wherein said composite material has a fracture toughness of between 0.6 and 1.5 GPa.

17. The system of claim 7, wherein said composite material has a compressive strength of between 300 and 900 MPa.

18. The system of claim 4, wherein said implant is made from a material allowing ossointegration.

19. The system of claim 18, wherein said material is selected from the group consisting of titanium, titanium alloy, gold, zirconium oxide and ceramics.

20. The system of claim 4 wherein said collar member is made from a material selected from the group consisting of titanium, titanium alloy, gold, zirconium oxide, and ceramics.

21. The system of claim 20, wherein said collar member is made from zirconium oxide.

22. The system of claim 20, wherein said collar member is made from a material selected from the group consisting of aluminum oxide, zirconium oxide and the like.

23. The system of claim 20, wherein said material has a density of between 2.4 and 6.2 g/cm³.

24. The system of claim 20, wherein said material has an elastic modulus of between 100 and 380 GPa.

25. The system of claim 20, wherein said material has a Poisson's ratio of between 0.22 and 0.34.

26. The system of claim 20, wherein said material has a flexural strength of between 200 and 1000 MPa.

27. The system of claim 20, wherein said material has a fracture toughness of between 2 and 15 MPa×m ½.

28. The system of claim 20, wherein said material has a hardness of between 6 and 15 GPa.

29. The system of claim 20, wherein said material has a CTE of between 9 and 11 10⁻⁶×° C.¹.

30. The system of claim 4, wherein said abutment is made from a highly filled composite material, wherein said collar member is made from a material selected from the group consisting of a zirconium oxide and a zircon ceramic and wherein said implant is made from titanium.

31. The system of claim 4, wherein said abutment further comprises an integral projection between said abutment head and said post, and wherein said first end of said implant includes a corresponding shouldered portion configured and sized to receive said projection.

32. The system of claim 31, wherein said projection and said shoulder portion have a shape selected from the group consisting of a substantially polygonal shape, a substantially oval shape and an irregular shape.

33. The system of claim 31, wherein said projection and said shoulder portion have a substantially cylindrical shape.

34. The system of claim 33, wherein said projection and said shouldered portion further comprise aligning means.

35. The system of claim 34, wherein said aligning means is selected from the group consisting of protrusions, notches, ridges and pins.

36. The system of claim 1, wherein said prosthesis support is made of a single piece.

37. The system of claim 1, wherein said post has a substantially smooth surface.

38. The system of claim 1, wherein the inner surface of said implant comprises a threaded section.

39. The system of claim 1, wherein the outer surface of said implant comprises a section selected from the group consisting of a threaded section, a grooved section, an eroded section, an etched section, and a rough section.

40. The system of claim 1, wherein the second closed end of said implant is tapered.

41. The system of claim 4, wherein said abutment head has a substantially frusto-conical shape.

42. The system of claim 4, wherein said abutment head has a substantially cylindrical shape.

43. The system of claim 4, wherein said abutment head has a substantially oval shape.

44. The system of claim 4, wherein said abutment further comprises a longitudinal throughbore extending therethrough.

45. The system of claim 4, wherein the abutment head defines an angle ranging from −35° to +35° with respect to the longitudinal axis of said implant, when said abutment and said implant are assembled.

46. The system of claim 4, wherein said collar member has a shape selected from the group consisting of a circular shape and an oval shape.

47. The system of claim 4, wherein said collar member is contoured.

48. The system of claim 31, wherein said collar member is contoured.

49. An implant system comprising:
a) an implant having an elongated tubular body extending about a central longitudinal axis, said implant having a first end and a second end, an inner surface and an outer surface, said first end being opened and including a shouldered portion and said second end being closed, and;
b) a cemented assembly comprising
an abutment including an abutment head, a projection for engagement within said shouldered portion, and a post; and
a collar member having a longitudinal passage therethrough;
wherein said abutment and said implant are so configured as to be fixed to each other by an attaching means other than a screwing means and wherein said projection and said shouldered portion being so configured as to allow assembly of said abutment with said implant in a linear translation insertion manner.

50. The system of claim 49, wherein said abutment is made from a highly filled composite material, wherein said collar member is made from a material selected from the group consisting of a zirconium oxide and a zircon ceramic and wherein said implant is made from titanium.

51. A method for installing the implant system of claim 4 into a bone tissue of individual in need, said method comprising:
a) installing the implant into a bone tissue;
b) shaping the abutment to a desired configuration, and;
c) assembling the prosthesis support onto the implant.

52. The method of claim 51, further comprising fixing the abutment with a composite cement.

53. The method of claim 52, further comprising the step of attaching a prosthesis to said prosthesis support.

54. The method of claim 51, wherein step b) is performed by a technique selected from the group consisting of a direct restorative technique and an indirect restorative technique.

55. A kit comprising an implant system as defined in claim 4.

56. The kit of claim 55, further comprising a cover screw.

57. The kit of claim 55, further comprising a healing screw.

58. The kit of claim 55, further comprising an impression copying.

59. The kit of claim 58, further comprising an impression copying attaching means.
